(19) United States
(12) Patent Application Publication
(10) Pub. No.: US 2003/0111311 A1
(43) Pub. Date: Jun. 19, 2003

(54) Vibration absorbing unit

(75) Inventors: Mamoru Saito, Niigata-ken (JP); Hideto Urasawa, Niigata-ken (JP); Yong-Rak Kwon, Athens, OH (US)

Correspondence Address: AKERMAN SENTERFITT, P.O. BOX 3188, WEST PALM BEACH, FL, 33402-3188, US

(73) Assignee: Twinbird Corporation, Niigata-ken (JP)

(21) Appl. No.: 10/301,456

(22) Filed: Nov. 21, 2002

(30) Foreign Application Priority Data
Dec. 13, 2001 (JP) 2001-380651

(51) Int. Cl. F16F 7/10; F16M 7/00; F16F 13/00

(52) U.S. Cl. 188/380; 267/140.11

(57) ABSTRACT

A vibration absorbing unit comprises: a casing 1 having a piston 3 which reciprocates and vibrates, a first fixed member 5 and a second fixed member 7 provided substantially orthogonal to a vibration direction Y of the piston 3, one weight 8 provided between the fixed members 5 and 7 so as to be substantially coaxial with the center of vibration of the piston 3, and a coil spring mechanism 12 fitted substantially parallel with the direction Y for suspending the weight 8 between the members 5 and 7. These components are provided inside the casing 1. In accordance with the vibration of the reciprocating piston 3, the weight 8 suspended by the coil spring mechanism 12 resonates inside the casing 1 with the vibration of the piston 3, so that the vibration transmitted to the casing 1 can be absorbed, and also the casing 1 can be made small.

### BACKGROUND OF THE INVENTION

1. Field of the Invention

The present invention relates to a vibration absorbing unit for absorbing vibration of equipment having a reciprocating vibration member, so that the vibration is not transmitted to the outside.

2. Description of the Related Art

Heretofore, as this kind of vibration absorbing unit, for example, one having a structure as shown in FIG. 8 is known. This unit comprises a spiral flat spring 53 provided outside of equipment 52 having a piston 51 built therein as a reciprocating vibrating part, so as to be orthogonal to a vibration direction Y of the piston 51, and a weight 54 fitted to the outer periphery of this spiral flat spring 53, so that the spiral flat spring 53 receives the vibration transmitted from the piston 51 to the equipment 52 and resonates with the equipment to absorb the vibration of the equipment 52. In the meantime, reference symbol 55 denotes a casing for the equipment, inside which is provided a built-in electromagnetic reciprocal movement driving mechanism 56 such as a linear motor, which enables the reciprocal movement of the piston 51 serving as a reciprocating vibrating part. Reference symbol 57 denotes a blade spring, connected with a displacer (not shown) via a connecting shaft 58. The amplitude of the displacer is controlled by these blade spring 57 and connecting shaft 58. Also, inert gas such as helium gas is filled in the casing 55. The casing 55 has a bottom 59 which is provided with the spiral flat spring 53 via a connecting portion 60.

However, since such a vibration absorbing unit is provided outside of the equipment 52, there is a problem in that the whole equipment 52 including the vibration absorbing unit becomes large. Moreover, since the vibration absorbing unit absorbs vibration by resonating with the equipment 52, that is, since the vibration absorbing unit itself vibrates, it may cause a problem when the equipment 52 using this vibration absorbing unit is assembled into an apparatus, and it is also dangerous due to the possibility of touching the vibrating vibration absorbing unit.

### SUMMARY OF THE INVENTION

It is an object of the present invention to provide a vibration absorbing unit, which can solve the above problems, and wherein the equipment having the vibration absorbing unit can be made small and can be assembled into an apparatus safely and reliably.

According to a first aspect of the invention, the vibration absorbing unit of the present invention comprises; a first fixed member provided substantially orthogonal to a vibration direction of equipment having a reciprocating vibrating part, a second fixed member provided substantially parallel with the first fixed member with a predetermined space therebetween, effectively one weight provided between the two fixed members so as to be substantially coaxial with the center of vibration of the vibrating part, and a coil spring mechanism fitted substantially parallel with the vibration direction of the vibrating part for suspending the weight between the fixed members, wherein the fixed members, the weight and the coil spring mechanism are provided inside the equipment.

Since the present invention has such a construction, the weight suspended by the coil spring mechanism resonates with the vibration of vibrating parts within the equipment, together with the vibration of the reciprocating vibrating part.

Furthermore, according to a second aspect of the invention, the vibration absorbing unit of the present invention has a construction such that, in the first aspect, the coil spring mechanism comprises; a first coil spring provided on the first fixed member side of the weight, and a second coil spring provided on the second fixed member side of the weight, and a spring constant of the first coil spring and a spring constant of the second coil spring are made equal.

Since the present invention has such a construction, the first coil spring expands or compresses, while the second coil spring compresses or expands, and hence the weight suspended between these coil springs reciprocates and vibrates.

Moreover, according to a third aspect of the invention, the vibration absorbing unit of the present invention has a construction such that, in the first aspect, the coil spring mechanism is formed by a single coil spring, and the weight is provided at an intermediate position of this coil spring.

Since the present invention has such a construction, opposite sides of the coil spring with the weight therebetween repeat expansion and compression alternately, and hence the weight suspended at the intermediate position of the coil spring reciprocates and vibrates.

Furthermore, according to a fourth aspect of the invention, the vibration absorbing unit of the present invention has a construction such that, in the second aspect, the first coil spring and the second coil spring are formed such that coiling directions thereof are opposite to each other.

Since the present invention has such a construction, the twisting direction when the first coil spring is compressed or expanded becomes opposite to that when the second coil spring is expanded or compressed.

Moreover, according to a fifth aspect of the invention, the vibration absorbing unit of the present invention has a construction such that, in the third aspect, the coil springs are formed such that coiling directions thereof are opposite referenced to an intermediate position.

Since the present invention has such a construction, the twisting direction when one of the coil springs is compressed or expanded becomes opposite to that when the other of the coil springs is expanded or compressed.

Furthermore, according to a sixth aspect of the invention, the vibration absorbing unit of the present invention has a construction such that, in the first aspect, a coil spring dropout prevention mechanism is provided for the respective fixed members, the coil spring mechanism or the weight.

Since the present invention has such a construction, when the vibrating part is vibrating, the coil spring mechanism and the weight vibrate without coming out from between the fixed members, and hence vibration transmitted from the vibrating part to the equipment is absorbed.

Moreover, according to a seventh aspect of the invention, the vibration absorbing unit of the present invention has a construction such that, in the sixth aspect, the coil spring dropout prevention mechanism is formed as a rod-shaped body more slender than the internal diameter of the coil spring mechanism, and the rod-shaped body is provided orthogonal to the two fixed members, and the rod-shaped body passes through the coil spring mechanism.

Since the present invention has such a construction, when the equipment is placed horizontally, then even if the weight suspended by the coil spring mechanism hangs down due to gravity, the weight is kept from deviating significantly from the center of vibration of the vibrating part by the rod-shaped body.

Furthermore, according to an eighth aspect of the invention, the vibration absorbing unit of the present invention has a construction such that, in the second aspect, one coil spring mechanism is provided, and the two fixed members, the coil spring mechanism and the weight are arranged coaxially.

Since the present invention has such a construction, the two coil springs abut against the whole perimeter of the two fixed members and the weight, so that the weight vibrates stably.

Furthermore, according to a ninth aspect of the invention, the vibration absorbing unit of the present invention has a construction such that, in the third aspect, one coil spring mechanism is provided, and the two fixed members, the coil spring mechanism and the weight are arranged coaxially.

Since the present invention has such a construction, the coil spring abuts against the whole perimeter of the two fixed members and the weight, so that the weight vibrates stably.

Moreover, according to a tenth aspect of the invention, the vibration absorbing unit of the present invention has a construction such that, in the first aspect, at least one of the fixed members is formed in an annular shape, and the internal diameter of the fixed member is formed larger than the external dimension of the vibrating part, and the reciprocating and vibrating equipment is located in a space bounded by an inner peripheral rim of the fixed member.

Since the present invention has such a construction, at least the first or second fixed members can be arranged so as to overlap the vibrating part.

Furthermore, according to an eleventh aspect of the invention, the vibration absorbing unit of the present invention has a construction such that, in the eighth aspect, an internal diameter of the coil spring mechanism is formed larger than that of the vibrating part.

Since the present invention has such a construction, not only the first fixed member but also the coil spring mechanism can be arranged so as to overlap the vibrating part.

Furthermore, according to a twelfth aspect of the invention, the vibration absorbing unit of the present invention has a construction such that, in the ninth aspect, an internal diameter of the coil spring mechanism is formed larger than that of the vibrating part.

Since the present invention has such a construction, not only the first fixed member but also the coil spring mechanism can be arranged so as to overlap the vibrating part.

Furthermore, according to a thirteenth aspect of the invention, the vibration absorbing unit of the present invention has a construction such that, in the tenth aspect, an internal diameter of the coil spring mechanism is formed larger than that of the vibrating part.

Since the present invention has such a construction, not only the first fixed member but also the coil spring mechanism can be arranged so as to overlap the vibrating part.

Moreover, according to a fourteenth aspect of the invention, the vibration absorbing unit of the present invention has a construction such that, in the first aspect, the weight is suspended by the coil spring mechanism at even-number places, and is formed so as to be asymmetric with respect to lines connecting opposite suspension places, and to be axisymmetric with respect to a central axis.

Since the present invention has such a construction, forces applied to adjacent coil spring mechanisms become different, and forces applied to opposite coil spring mechanisms become the same. As a result, oscillating vibration of the weight itself can be suppressed, and the weight precisely reciprocates and vibrates.

### BRIEF DESCRIPTION OF THE DRAWINGS

FIG. 1 is a cross-section of equipment using a vibration absorbing unit, illustrating a first embodiment of the present invention.

FIG. 2 is a plan view of a weight shown in FIG. 1.

FIG. 3 is a cross-section of the weight shown in FIG. 1.

FIG. 4 is a cross-section of equipment using a vibration absorbing unit, illustrating a second embodiment of the present invention.

FIG. 5 is a cross-section of equipment using a vibration absorbing unit, illustrating a third embodiment of the present invention.

FIG. 6 is an enlarged cross-section of FIG. 5.

FIG. 7 is a cross-section of equipment using a vibration absorbing unit, illustrating a fourth embodiment of the present invention.

FIG. 8 is a cross-section of equipment using a vibration absorbing unit illustrating the prior art.

### DESCRIPTION OF THE PREFERRED EMBODIMENTS

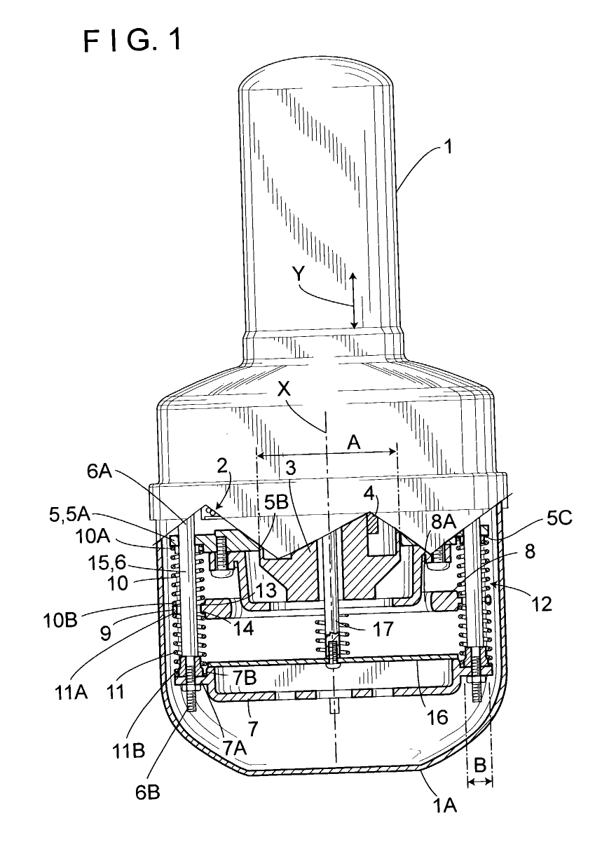

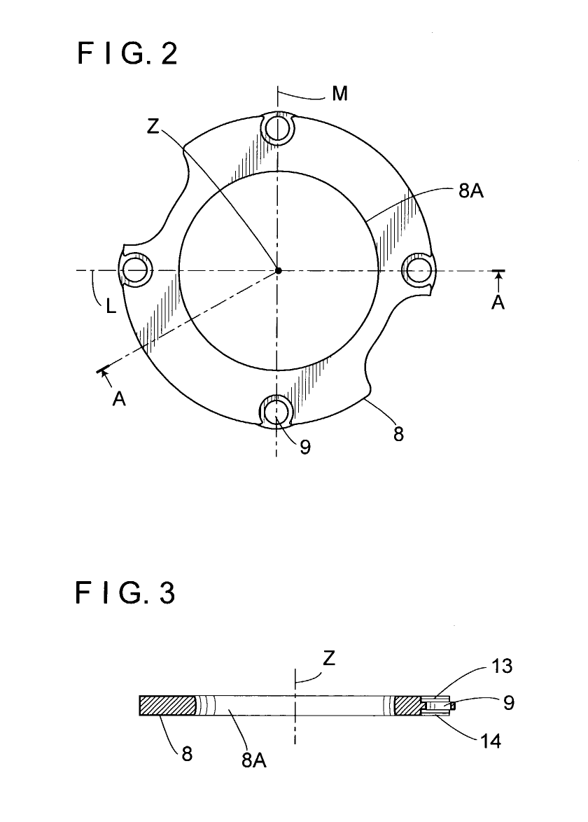

Embodiments of the present invention will now be described, with reference to the drawings. FIG. 1 through FIG. 3 show a first embodiment. In these figures, reference symbol 1 denotes a casing of the equipment. An electromagnetic reciprocating drive mechanism 2 such as a linear motor is built into this casing 1, and a piston 3, being a vibrating part, is accommodated in a cylinder 4 so as to be able to reciprocate and slide in a direction of a central axis X, by means of the electromagnetic reciprocating drive mechanism 2. Reference symbol 5 denotes an annular first fixed member which is fitted to an end of the electromagnetic reciprocating drive mechanism 2, with a flat portion 5A substantially orthogonal to the central axis X. One end 6A of a rod-shaped body 6 is connected to the first fixed member 5. This rod-shaped body 6 is arranged parallel with the central axis X, with an other end 6B directed towards the inside of a bottom 1A of the casing 1, and is provided between the first fixed member 5 and a second fixed member 7 in even numbers, in this example four, and at equal spacing. The second fixed member 7 having a flat portion 7A formed in an annular shape, is connected to the other ends 6B of the plurality of rod-shaped bodies 6. The second fixed member 7 is arranged on the bottom 1A side, parallel with the first fixed member 5. The flat portion 7A at the edge thereof is substantially orthogonal to the central axis X, and the other ends 6B of the rod-shaped bodies 6 are connected to this edge. Reference symbol 8 denotes a weight provided between the fixed members 5 and 7, so as to be substantially coaxial with the center of vibration of the piston 3. The weight 8 is an annular shape with a cavity 8A formed in the radial center. The rod-shaped bodies 6 pass through a plurality of through holes 9 formed in even-number places at the edge of the weight 8, in this figure, at four evenly spaced places, so that the weight 8 can reciprocate along the axial direction of the rod-shaped bodies 6.

A diameter A of an inner peripheral rim 5B of the first fixed member 5 is formed larger than the external dimension of the piston 3, so that the piston 3, being the vibrating part, is located in the space bounded by the inner peripheral rim 5B of the first fixed member 5, in a direction of the central axis X (that is, in a vibration direction Y). The weight 8 is suspended by a coil spring mechanism 12 described later, between the fixed members 5 and 7 at the edge where the four through holes 9 are formed, and is formed so as to be asymmetric with respect to lines L and M connecting opposite through holes 9, being the suspension places, and to be axisymmetric with respect to a central axis Z.

Reference symbol 10 denotes a first coil spring provided on the first fixed member 5 side of the weight 8, and reference symbol 11 denotes a second coil spring provided on the second fixed member 7 side of the weight 8. Internal diameters B of the first coil spring 10 and the second coil spring 11 are formed larger than the diameter of the rod-shaped body 6, and the first coil spring 10 and the second coil spring 11 are provided so that the rod-shaped bodies 6 pass upwards through the axial center thereof. The first coil spring 10 and second coil spring 11 are provided in the same number, and in this example, four. The first coil spring 10 and the second coil spring 11 have the same spring constant, the same number of turns and the same length, and are formed so that the coiling directions thereof are opposite to each other, with the weight 8 therebetween. The weight 8 is suspended between the fixed members 5 and 7 by the first coil spring 10 and the second coil spring 11, to thereby form the coil spring mechanism 12, which allows the weight 8 to vibrate substantially parallel with the vibration direction Y of the piston 3. Four pairs of coil spring mechanisms 12 constructed in this manner are located outward of the space bounded by the inner peripheral rim 5B of the first fixed member 5, in a direction of the central axis X (that is, in the vibration direction Y). The fixed members 5 and 7, the four pairs of the coil spring mechanisms 12 and the weight 8 are arranged coaxially about the central axis Z. The first coil spring 10 is engaged with the first fixed member 5 at one end 10A, and with the weight 8 at the other end 10B. Moreover, the one end 10A of the first coil spring 10 formed with a flat portion so as to be orthogonal to the central axis X is engaged in a depression 5C formed in the flat portion 5A of the first fixed member 5, and the other end 10B of the first coil spring 10 similarly formed with a flat portion, is engaged in a depression 13 of the weight 8 formed in the rim on the first fixed member 5 side, thereby preventing dropout. Similarly, one end 11A of the second coil spring 11 formed with a flat portion is engaged in a depression 14 of the weight 8 formed in the rim on the second fixed member 7 side, and the other end 11B of the second coil spring 11 formed with a flat portion is engaged in a depression 7B formed in the flat portion 7A of the second fixed member 7, thereby preventing dropout. The rod-shaped bodies 6, which are provided orthogonal to the fixed members 5 and 7, are passed through the center of the axes of the coil springs 10 and 11 (coil spring mechanism 12), to thereby form a coil spring dropout prevention mechanism 15.

In the figures, reference symbol 16 denotes a flat spring, which is connected to a displacer (not shown), via a connecting shaft 17 provided passing through the piston 3, and by means of the flat spring 16 and the connecting shaft 17, the amplitude of the displacer is controlled. An inert gas such as a helium gas is filled into the casing 1.

The operation of the above described construction will now be described. When the piston 3 reciprocates in the direction of central axis X (in the vibration direction Y) inside the cylinder 4 by the electromagnetic reciprocating drive mechanism 2, the first coil spring 10 expands or compresses together with the vibration of the reciprocating piston 3, and the second coil spring 11 compresses or expands. As a result, the weight 8 suspended between these coil springs 10 and 11 resonates with the vibration of the piston 3, inside of the casing 1, and hence vibration transmitted from the piston 3 to the casing 1 of the equipment is absorbed. At this time, since the first coil spring 10, the second coil spring 11 and the weight 8 are retained by the rod-shaped bodies 6, the coil spring mechanism 12 and the weight 8 vibrate without coming out from between the fixed members 5 and 7. Coil springs generally twist at the time of being expanded or compressed, and the twisting direction is different depending on the coiling direction. When the coiling directions of the first coil spring 10 and the second coil spring 11 are made opposite to each other, as in this example, the twisting direction at the other end 10B of the first coil spring 10 at the time of expansion, and the twisting direction at the one end 11A of the second coil spring 11 at the time of compression become opposite. Similarly, the twisting direction at the other end 10B of the first coil spring 10 at the time of compression and the twisting direction at the one end 11A of the second coil spring 11 at the time of expansion become opposite. Therefore, when the weight 8 is vibrating, a twisting force applied to the weight 8 by the expansion and compression of the coil springs 10 and 11 becomes opposite at the other end 10B of the first coil spring 10 and at the one end 11A of the second coil spring 11. As a result, a force applied to the weight 8 in a direction about the axis of the coil springs 10 and 11 is compensated. Therefore, the weight 8 vibrates in the vibration direction Y, and rotation of the weight 8 about the central axis Z is prevented. Furthermore, since an inert gas such as a helium gas is filled in the casing 1, the coil springs 10 and 11 do not become rusty. Hence, even if the coil springs 10 and 11 repeat expansion and compression at a high speed due to the weight 8 resonating with the vibration of the piston 3, the coil springs 10 and 11 are not damaged as a result of rust.

As described above, in this embodiment, the vibration absorbing unit comprises; the first fixed member 5 provided substantially orthogonal to the vibration direction Y of the piston 3 reciprocating in the cylinder 4 fitted in the casing 1, the second fixed member 7 provided substantially parallel with the first fixed member 5 with a predetermined space therebetween, one weight 8 provided between the both fixed members 5 and 7 so as to be substantially coaxial with the center of vibration of the piston 3, and the coil spring mechanism 12 fitted substantially parallel with the vibration direction Y of the piston 3 for suspending the weight 8 between the fixed members 5 and 7. These fixed members 5 and 7, the weight 8 and the coil spring mechanism 12 are provided inside the casing 1. Since the weight 8 suspended by the coil spring mechanism 12 resonates inside the casing 1 with the vibration of the reciprocating piston 3, not only can the overall equipment be made small, but also by housing the self vibrating weight 8 inside the casing 1, this can be safely assembled in an apparatus.

The coil spring mechanism 12 comprises the first coil spring 10 provided on the first fixed member 5 side of the weight 8, and the second coil spring 11 provided on the second fixed member 7 side of the weight 8, and the spring constant of the first coil spring 10 and the spring constant of the second coil spring 11 are made equal. Since the first coil spring 10 is expanded or compressed, while the second coil spring 11 is compressed or expanded, the weight 8 suspended between these coil springs 10 and 11 resonates with the vibration of the piston 3. As a result, vibration transmitted from the piston 3 to the casing 1 of the equipment can be absorbed.

The coil springs 10 and 11 are constructed such that coiling directions thereof are opposite, with the weight 8 therebetween. Since the twisting direction when the first coil spring 10 is compressed or expanded becomes opposite to that when the second coil spring 11 is expanded or compressed, a rotation force applied to the weight 8 is compensated, and rotation of the weight 8 about the central axis Z is prevented.

The coil spring dropout prevention mechanism 15 is provided for the respective fixed members 5 and 7, the coil spring mechanism 12 or the weight 8, so that when the piston 3 is vibrating, the coil spring mechanism 12 and the weight 8 vibrate without coming out from between the fixed members 5 and 7. As a result, vibration transmitted from the piston 3 to the casing 1 of the equipment can be reliably absorbed.

The coil spring dropout prevention mechanism 15 is formed as a rod-shaped body 6 more slender than the internal diameter B of the coil spring mechanism 12, and this rod-shaped body 6 is provided orthogonal to the fixed members 5 and 7, and the rod-shaped body 6 passes through the coil spring mechanism 12. When the casing 1 is placed horizontally, even if the weight 8 suspended by the coil spring mechanism 12 hangs down due to gravity, the weight 8 is kept from deviating significantly from the central axis X of the piston 3 by the rod-shaped body 6. As a result, the possibility that the effect of absorbing vibration deteriorates because of the center of vibration of the piston 3 deviating significantly from the center of vibration of the weight 8 can be largely prevented.

The fixed member 5 is formed in an annular shape, and the internal diameter A of the fixed member 5 is formed larger than the external dimension of the piston 3, and the reciprocating and vibrating piston 3 is located in a space bounded by the inner peripheral rim of the fixed member 5, in the direction of the central axis X (in a vibration direction Y). As a result, the fixed member 5 and the piston 3 can be arranged so as to overlap each other, and hence the dimension of the casing 1 can be made small in the vibration direction Y of the piston 3.

The weight 8 is suspended by the coil spring mechanism 12 at even-number places, that is, at four places, and is formed so as to be asymmetric with respect to lines L and M connecting opposite through holes 9, being the suspension places, and to be axisymmetric with respect to the central axis Z. Therefore, forces applied to the adjacent coil spring mechanisms 12 become different, and forces applied to the opposite coil spring mechanisms 12 become the same. As a result, oscillating vibration of the weight 8 itself can be suppressed, and the weight 8 precisely reciprocates and vibrates in the vibration direction Y.

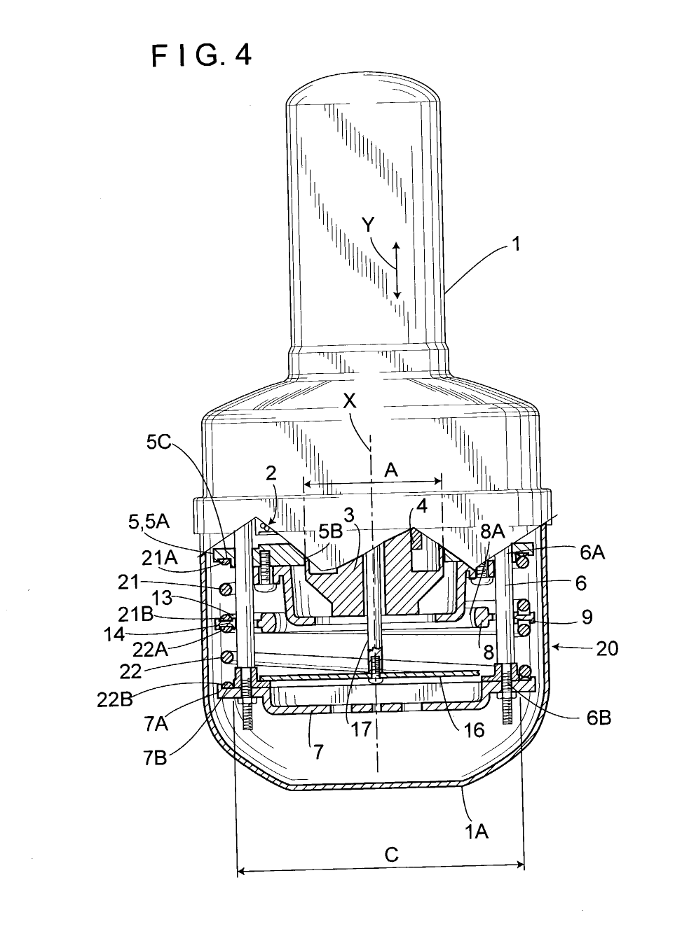

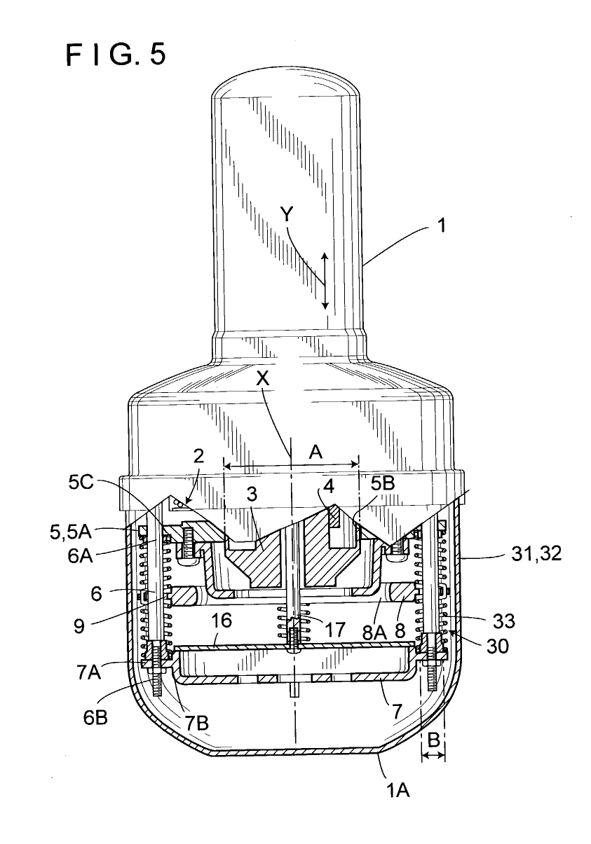

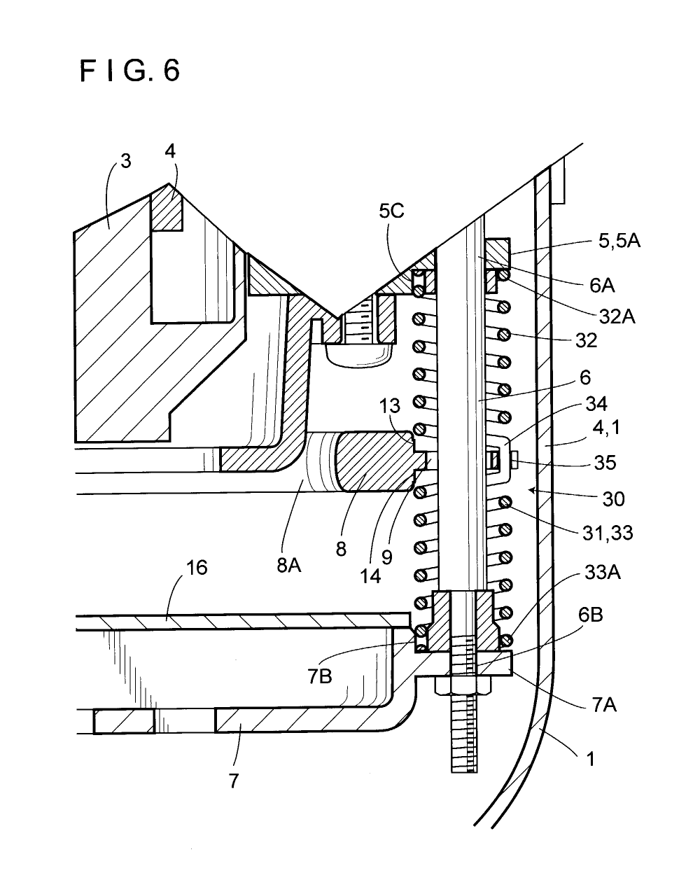

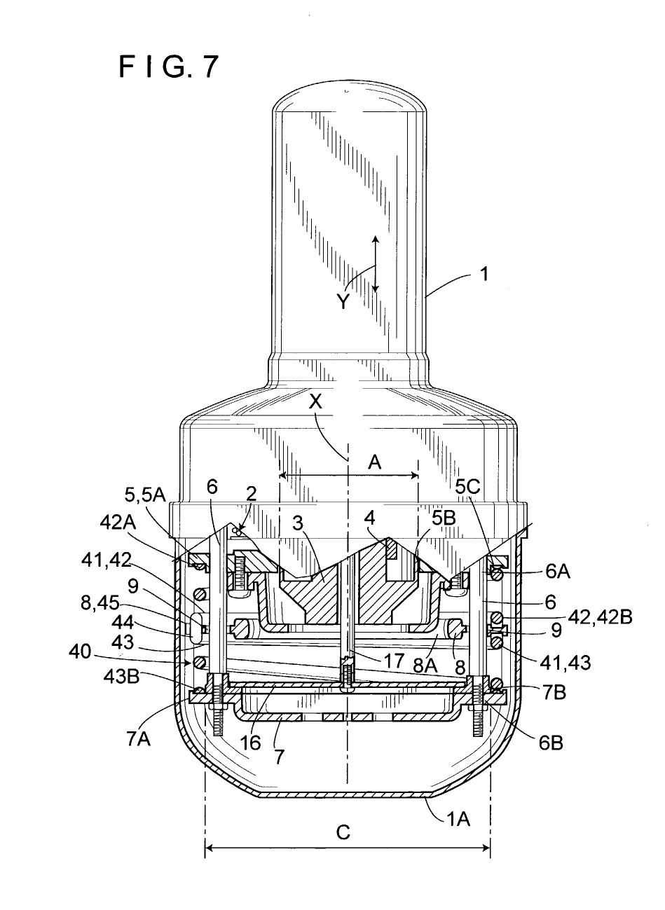

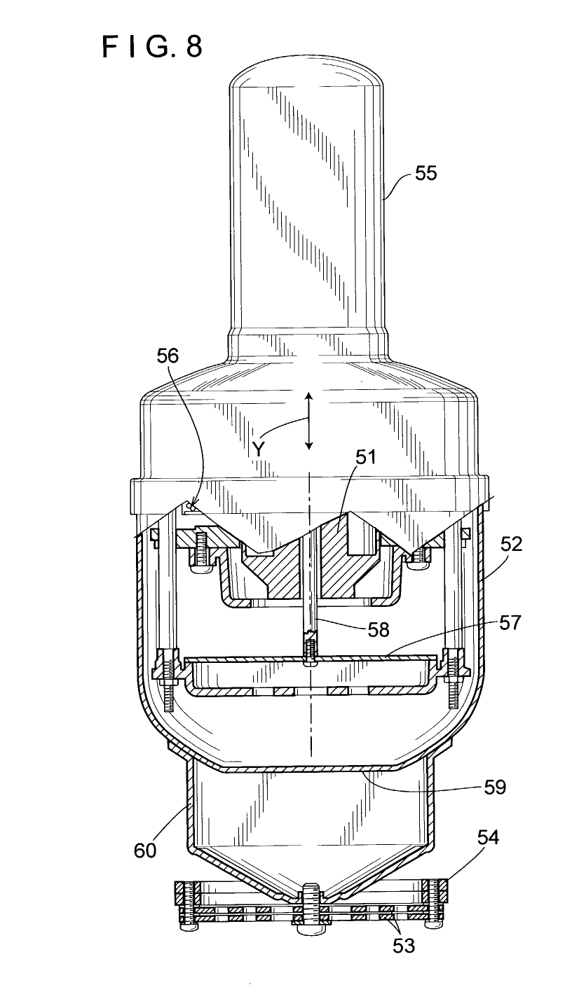

Second, third and fourth embodiments will now be described, with reference to FIG. 4, FIG. 5 and FIG. 6, and FIG. 7. The same parts as those in the first embodiment are denoted by the same reference symbols, and the detailed description thereof is omitted. In the second embodiment shown in FIG. 4, a coil spring mechanism 20 comprises a first coil spring 21 and second coil spring 22 pair, having a large diameter and arranged so that the central axis thereof becomes substantially the same as the central axis X. The first coil spring 21 is arranged between a first fixed member 5 and a weight 8, and the second coil spring 22 is arranged between the weight 8 and a second fixed member 7. The first coil spring 21 and the second coil spring 22 have the same spring constant, the same number of turns and the same length, and are formed so that the coiling directions thereof are opposite to each other, with the weight 8 therebetween. Internal diameters C of the first coil spring 21 and the second coil spring 22 are formed slightly larger than the distance between the outsides of opposite rod-shaped bodies 6, so as to cover the outside of the four rod-shaped bodies 6 provided at equal spacing, between the fixed members 5 and 7. Flat portions are formed at one end 21A and the other end 21B of the first coil spring 21 so as to be orthogonal to the central axis X of the piston 3 and the coil spring mechanism 20, and the one end 21A and the other end 21B are engaged in depressions 5C and 13, respectively. Similarly, flat portions are formed at one end 22A and the other end 22B of the second coil spring 22 so as to be orthogonal to the central axis X of the piston 3 and the coil spring mechanism 20, and the one end 22A and the other end 22B are engaged in depressions 14 and 7B, respectively.

Therefore, in the second embodiment, when the piston 3 reciprocates in the cylinder 4 in the direction of the central axis X (in the vibration direction Y), the first coil spring 21 expands or compresses together with the vibration of the reciprocating piston 3, and the second coil spring 22, whose coiling direction is opposite to that of the first coil spring 21, compresses or expands. As a result, the weight 8 suspended between these coil springs 21 and 22 reciprocates and vibrates, so that the weight 8 suspended by the coil spring mechanism 20 resonates with the vibration of the piston 3, inside of the casing 1, and hence vibration transmitted from the piston 3 to the casing 1 of the equipment is absorbed. Since the coiling directions of the first coil spring 21 and the second coil spring 22 are made opposite to each other, the twisting direction at the other end 21B of the first coil spring 21 at the time of expansion, and the twisting direction at the one end 22A of the second coil spring 22 at the time of compression become opposite. Similarly, the twisting direction at the other end 21B of the first coil spring 21 at the time of compression and the twisting direction at the one end 22A of the second coil spring 22 at the time of expansion become opposite. Therefore, when the weight 8 is vibrating, a twisting force applied to the weight 8 by the expansion and compression of the coil springs 21 and 22 becomes opposite at the other end 21B of the first coil spring 21 and at the one end 22A of the second coil spring 22. As a result, a force applied to the weight 8 in the direction about the axis of the coil springs 21 and 22 is compensated. Therefore, the weight 8 vibrates in the vibration direction Y, and rotation of the weight 8 about the central axis Z is prevented.

As described above, in this embodiment, since the coil spring mechanism 20 is formed of the first coil spring 21 and second coil spring 22 pair having a large diameter, which are arranged so that the central axis thereof becomes substantially the same as the central axis X of the piston 3, only a pair of coil springs 21 and 22 is necessary. As a result, in addition to the effects obtained in the first embodiment, the number of parts can be reduced and ease of assembly improved. Furthermore, by providing one coil spring mechanism 20, and arranging the fixed members 5 and 7, the coil spring mechanism 20 and the weight 8 coaxially, so that both the coil springs 21 and 22 abut against the whole perimeter of the fixed members 5 and 7 and the weight 8, the weight 8 can vibrate stably.

In the third embodiment shown in FIG. 5 and FIG. 6, a coil spring mechanism 30 is formed from a single coil spring 31. The coil spring 31 comprises one end portion 32, an other end portion 33, and a connection section 34, being an intermediate position for integrally connecting the one end portion 32 and the other end portion 33. The one end portion 32 is arranged between a first fixed member 5 and a weight 8, and the other end portion 33 is arranged between the weight 8 and a second fixed member 7. The connection section 34 is engaged in a notch 35 formed outside of a through hole 9 of the weight 8. The one end portion 32 and the other end portion 33 have the same spring constant, the same number of turns and the same length, and are formed so that the coiling directions thereof are opposite to each other, with the connection section 34 therebetween. An internal diameter B of the coil spring 31 is formed larger than that of the rod-shaped body 6, so that the rod-shaped body 6 passes through the central axis of the coil spring 31. By passing the rod-shaped body 6 provided orthogonal to the fixed members 5 and 7, through the central axis of the coil spring 31 (coil spring mechanism 30), a coil spring dropout prevention mechanism 15 is formed. Four coil springs 31 and four rod-shaped bodies 6 are provided at equal spacing, between the fixed members 5 and 7. The four pairs of coil spring mechanisms 30 formed in this manner are located outward of a space bounded by the inner peripheral rim 5B of the first fixed member 5, in the direction of the central axis X (in the vibration direction Y), and the fixed members 5 and 7, the four pairs of coil spring mechanisms 30 and the weight 8 are coaxially arranged about the central axis X. An end 32A of the one end portion 32 is formed with a flat portion so as to be orthogonal to the central axis X of the piston 3, and the end 32A is engaged in a depression 5C. Similarly, an end 33A of the other end portion 33 is formed with a flat portion so as to be orthogonal to the central axis X, and the end 33A is engaged in a depression 7B.

Therefore, in the third embodiment, when the piston 3 reciprocates in the direction of the central axis X (in the vibration direction Y), inside the cylinder 4, the weight 8 suspended by the connection section 34 of the coil spring 31 resonates with the vibration of the piston 3. At this time, the one end portion 32 and the other end portion 33 of the coil spring 31 respectively having a twisting direction opposite to each other with the weight 8 therebetween, repeat expansion and compression alternately. The weight 8 suspended by the coil spring mechanism 30 resonates with the vibration of the piston 3, inside of the casing 1, to thereby absorb vibration transmitted from the piston 3 to the casing 1 of the equipment. Since the coiling directions of the one end portion 32 and the other end portion 33 of the coil spring 31 are formed opposite to each other, the twisting direction on the connection section 34 side at the time of expansion of the one end portion 32 becomes opposite to that on the connection section 34 side at the time of compression of the other end portion 33. Similarly, the twisting direction on the connection section 34 side at the time of compression of the one end portion 32 becomes opposite to that on the connection section 34 side at the time of expansion of the other end portion 33. Therefore, when the weight 8 is vibrating, a twisting force applied to the weight 8 by the expansion and compression of the coil spring 31 becomes opposite on the one end portion 32 side and on the other end portion 33 side. As a result, a force applied to the weight 8 in a direction about the axis of the coil spring 31 is compensated. Therefore, the weight 8 vibrates in the vibration direction Y, and rotation of the weight 8 about the central axis Z is prevented.

As described above, in this embodiment, the coil spring mechanism 30 is formed from a single coil spring 31, and the weight 8 is provided at the connection section 34 of the coil spring 31. When the piston 3 reciprocates in the cylinder 4 in the direction of the central axis X (in the vibration direction Y), the weight 8 suspended by the connection section 34 of the coil spring 31 resonates with the piston 3, so that the one end portion 32 and the other end portion 33 repeat expansion and compression alternately, and the weight 8 reciprocates. As a result, vibration transmitted from the piston 3 to the casing 1 of the equipment can be absorbed.

In the fourth embodiment shown in FIG. 7, a coil spring mechanism 40 is formed of a single coil spring 41 having a large diameter, arranged so that the central axis thereof is substantially the same as the central axis X. This coil spring 41 comprises one end portion 42, an other end portion 43, and a connection section 44, being an intermediate position for integrally connecting the one end portion 42 and the other end portion 43. The one end portion 42 is arranged between a first fixed member 5 and a weight 8, and the other end portion 43 is arranged between the weight 8 and a second fixed member 7. The connection section 44 is engaged in a notch 35 formed on the outside of a through hole 9 of the weight 8. The one end portion 42 and the other end portion 43 have the same spring constant, the same number of turns and the same length, and are formed so that the coiling directions thereof are opposite to each other, with the connection section 44 therebetween. An internal diameter C of the coil spring 41 is formed slightly larger than the distance between the outside of opposite rod-shaped bodies 6, so as to cover the outside of the four rod-shaped bodies 6 provided at equal spacing, between the fixed members 5 and 7. One end 42A and an other end 42B of the one end portion 42 of the coil spring 41 are formed with a flat portion so as to be orthogonal to the central axis X of the piston 3 and the coil spring mechanism 40, and the one end 42A and the other end 42B are engaged in depressions 5C and 13, respectively. Similarly, one end 43A and an other end 43B of the other end portion 43 of the coil spring 41 are formed with a flat portion so as to be orthogonal to the central axis X of the piston 3 and the coil spring mechanism 40, and the one end 43A and the other end 43B are engaged in depressions 14 and 7B, respectively.

Therefore, in the fourth embodiment, when the piston 3 reciprocates in the direction of the central axis X (in the vibration direction Y), inside the cylinder 4, the weight 8 suspended by the connection section 44 of the coil spring 41, resonates with the vibration of the piston 3. At this time, the one end portion 42 and the other end portion 43 of the coil spring 41 respectively having a twisting direction opposite to each other with the weight 8 therebetween, repeat expansion and compression alternately. The weight 8 suspended by the coil spring mechanism 40 resonates with the vibration of the piston 3, inside of the casing 1, to thereby absorb vibration transmitted from the piston 3 to the casing 1 of the equipment. Since the coiling directions of the one end portion 42 and the other end portion 43 of the coil spring 41 are formed opposite to each other, the twisting direction on the connection section 44 side at the time of expansion of the one end portion 42 becomes opposite to that on the connection section 44 side at the time of compression of the other end portion 43. Similarly, the twisting direction on the connection section 44 side at the time of compression of the one end portion 42 becomes opposite to that on the connection section 44 side at the time of expansion of the other end portion 43. Therefore, when the weight 8 is vibrating, a twisting force applied to the weight 8 by the expansion and compression of the coil spring 41 becomes opposite on the one end portion 42 side and on the other end portion 43 side. As a result, a force applied to the weight 8 in a direction about the axis of the coil spring 41 is compensated. Therefore, the weight 8 vibrates in the vibration direction Y, and rotation of the weight 8 about the central axis Z is prevented.

As described above, in this embodiment, the coil spring mechanism 40 is formed from a single coil spring 41, and the weight 8 is provided at the connection section 44 of the coil spring 41. When the piston 3 reciprocates in the cylinder 4 in the direction of the central axis X (in the vibration direction Y), the weight 8 suspended by the connection section 44 of the coil spring 41 resonates with the piston 3, so that the one end portion 42 and the other end portion 43 repeat expansion and compression alternately, and the weight 8 reciprocates. As a result, vibration transmitted from the piston 3 to the casing 1 of the equipment can be absorbed. Moreover, since there is only one coil spring, the number of parts can be reduced, and ease of assembly improved. Furthermore, by providing one coil spring mechanism 40, and arranging the fixed members 5 and 7, the coil spring mechanism 40 and the weight 8 coaxially, so that the coil spring 41 abuts against the whole perimeter of the fixed members 5 and 7 and the weight 8, the weight 8 can vibrate stably.

The present invention is not limited to the above described embodiments, and various modifications are possible within the scope of the gist of the present invention. For example, in the respective embodiments, only one weight is provided, but the weight may be formed with a plurality of weights overlapped or connected, so as to operate effectively as one weight. In the respective embodiments, only the first fixed member is formed in an annular shape, but the second fixed member may be also formed in an annular shape. In this case, the whole vibration absorbing unit comprising the both fixed members, the coil spring mechanism and the weight can be arranged so as to overlap the vibrating part. Moreover, in the first embodiment, the first coil spring and the second coil spring are formed so that the coiling directions thereof are opposite to each other. However, these may be formed such that at the same time, the coiling directions of the adjacent first coil springs and the adjacent second coil springs also become opposite to each other. In this case, when the weight is vibrating, a twisting force applied to the weight by the expansion and compression of the first and second coil springs not only becomes opposite at the other end of the first coil spring and at the one end of the second coil spring, but also becomes opposite for the adjacent first coil springs and the adjacent second springs. As a result, a force applied to the weight in a direction about the axis of the first and second coil springs is compensated, and rotation of the weight 8 about the central axis Z is prevented more reliably. Similarly, in the third embodiment, the construction may be such that the coiling directions of the one end portions of the adjacent coil springs, and coiling directions of the other end portions of the adjacent coil springs are opposite to each other.

What is claimed is:

1. A vibration absorbing unit comprising; a first fixed member provided substantially orthogonal to a vibration direction of equipment having a reciprocating vibrating part, a second fixed member provided substantially parallel with said first fixed member with a predetermined space therebetween, effectively one weight provided between the two fixed members so as to be substantially coaxial with the center of vibration of said vibrating part, and a coil spring mechanism fitted substantially parallel with the vibration direction of said vibrating part for suspending the weight between the fixed members, wherein these fixed members, the weight and the coil spring mechanism are provided inside said equipment.

2. A vibration absorbing unit according to claim 1, wherein said coil spring mechanism comprises; a first coil spring provided on the first fixed member side of the weight, and a second coil spring provided on the second fixed member side of the weight, and a spring constant of the first coil spring and a spring constant of the second coil spring are made equal.

3. A vibration absorbing unit according to claim 1, wherein said coil spring mechanism is formed by a single coil spring, and the weight is provided at an intermediate position of said coil spring.

4. A vibration absorbing unit according to claim 2, wherein said first coil spring and said second coil spring are formed such that coiling directions thereof are opposite to each other.

5. A vibration absorbing unit according to claim 3, wherein said coil springs are formed such that coiling directions thereof are opposite referenced to an intermediate position.

6. A vibration absorbing unit according to claim 1, wherein a coil spring dropout prevention mechanism is provided for said fixed members, said coil spring mechanism or said weight.

7. A vibration absorbing unit according to claim 6, wherein said coil spring dropout prevention mechanism is formed as a rod-shaped body more slender than the internal diameter of the coil spring mechanism, and said rod-shaped body is provided orthogonal to said two fixed members, and said rod-shaped body passes through said coil spring mechanism.

8. A vibration absorbing unit according to claim 2, wherein one coil spring mechanism is provided, and said two fixed members, said coil spring mechanism and said weight are arranged coaxially.

9. A vibration absorbing unit according to claim 3, wherein one coil spring mechanism is provided, and said two fixed members, said coil spring mechanism and said weight are arranged coaxially.

10. A vibration absorbing unit according to claim 1, wherein at least one of said fixed members is formed in an annular shape, and the internal diameter of said fixed member is formed larger than the external dimension of said vibrating part, and said reciprocating and vibrating equipment is located in a space bounded by an inner peripheral rim of said fixed member.

11. A vibration absorbing unit according to claim 8, wherein an internal diameter of said coil spring mechanism is formed larger than that of said vibrating part.

12. A vibration absorbing unit according to claim 9, wherein an internal diameter of said coil spring mechanism is formed larger than that of said vibrating part.

13. A vibration absorbing unit according to claim 10, wherein an internal diameter of said coil spring mechanism is formed larger than that of said vibrating part.

14. A vibration absorbing unit according to claim 1, wherein said weight is suspended by said coil spring mechanism at even-number places, and is formed so as to be asymmetric with respect to lines connecting opposite suspension places, and to be axisymmetric with respect to a central axis.
